(19) United States
(12) Patent Application Publication
(10) Pub. No.: US 2005/0036603 A1
(43) Pub. Date: Feb. 17, 2005

(54) User-defined ring tone file

(76) Inventor: David A. Hughes, New York, NY (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/814,099

(22) Filed: Mar. 31, 2004

Related U.S. Application Data
(60) Provisional application No. 60/479,092, filed on Jun. 16, 2003.

(51) Int. Cl. H04M 11/00; H04M 3/00

(52) U.S. Cl. 379/372; 455/567; 455/426.1; 455/418

(57) ABSTRACT

A handset user defines a ring tone for a wireless communications handset. The user outputs a master recording and designates ring tone start and stop times. A ring tone file is defined between the start and stop designations, and the defined ring tone file is stored for selection by the user.

### STATEMENT OF RELATED APPLICATION

This application claims the benefit of priority to U.S. Provisional Patent Application Ser. No. 60/479,092, filed Jun. 16, 2003, entitled “User-Defined Ring Tone File,” which is incorporated by reference herein in its entirety.

### BACKGROUND

1. Field of Invention

The invention relates to call signal generating, and more specifically to defining ring tone files used to alert handset users.

2. Related Art

A ringing bell traditionally alerted a telephone system subscriber of an incoming call. Handsets (e.g., cellular telephony wireless handsets, pagers, personal digital assistants with wireless communication capability, and other communications terminals) typically use an electronic data file (a “ring tone file”) to simulate a ringing or other sound that alerts a communications system subscriber (a “user”) of an inbound communication or of an alarm of some sort. The use of an electronic ring tone file allows the user to select a desired audio output to be the ring tone. Users may designate, for example, various ringing bell patterns, songs, sound effects, animal noises, etc. that the handset will output. Although a large number of such ring tone files and associated ring tones exist, users are not able to easily create custom ring tones and make such custom ring tones available for use on their handsets.

### SUMMARY

In accordance with one aspect of the present invention, a handset receives an electronic data file that includes a master recording. The user will use a portion of the master recording as a ring tone on the handset. The handset receives (for example, a user enters) a ring tone start designation as the master recording is output. The handset also receives (for example, the user also enters) a ring tone stop designation. In one instance the stop designation is an elapsed time after the entered start designation. In another instance the user enters the stop designation during the master recording output. The start and stop designations are used to create a ring tone file that corresponds to a portion of the master recording data file. The created ring tone file is made available for selection by a user. The electronic data file may be received via a wireless signal, and the ring tone file may be associated with an input communication source, such as a paging system or a telephone system.

In accordance with another aspect of the present invention, a computer-readable storage medium is encoded with a computer program which, when loaded into a processor, implements on or more aspects of the foregoing method.

In accordance with a further aspect of the present invention, a handset, which may be a wireless handset such as a cellular phone, personal digital assistant, or a pager, includes a processor, a memory coupled to the processor, a user interface coupled to the processor, and a user-defined ring tone file stored in the memory. The stored ring tone file is defined by the user entering a ring tone start designation for a master recording data file and by the user entering a ring tone stop designation for the master recording data file. The ring tone stop designation may be an elapsed time after the ring tone start designation. The user-defined ring tone file may be associated with an input communication source, such as a paging system or a telephone system. The telephone system may be a multiline telephone system.

According to a still further aspect of the present invention, a method of manufacturing a wireless handset includes the acts of: configuring the handset to receive (for example, via a wireless signal) an electronic data file comprising a master recording; configuring the handset to receive a first user input, wherein the first user input enables the user to input a ring tone start designation for a first time during an output of the master recording; configuring the handset to receive a second user input, wherein the second user input enables the user to input a ring tone stop designation for a second time during the output of the master recording; configuring the handset to create a ring tone file from a portion of the electronic data file defined by the start designation and the stop designation; and configuring the handset to make the ring tone file available for selection by the user.

The ring tone ring tone stop designation may be an elapsed time after the ring tone start designation. The user-defined ring tone file may be associated with an input communication source, such as a paging system or a telephone system.

### BRIEF DESCRIPTION OF DRAWINGS

FIG. 1 is a diagrammatic view of a wireless handset.

FIG. 2 is a diagrammatic view of a ring tone file creation method.

FIG. 3 is a diagrammatic view of a second ring tone file creation method.

### DETAILED DESCRIPTION

It will be understood that many well-known features (e.g., power supplies) have been omitted from the description and the accompanying drawing so as to more clearly illustrate embodiments of the invention. Software coding (e.g., using a version of the “C” programming language) will be routine in light of this description.

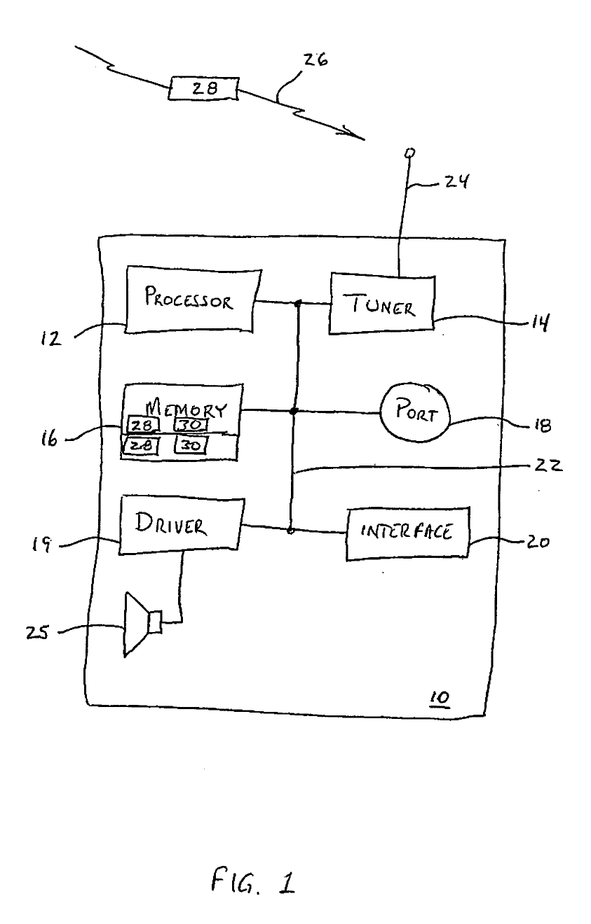

FIG. 1 is a diagrammatic view of a handset 10 (e.g., cellular telephony wireless handset, personal digital assistant with wireless communication ability, paging device, etc.) in accordance with the invention. As shown in FIG. 1, processor 12 (e.g., microprocessor/microcontroller), cellular telephone wireless tuner 14, memory 16 (e.g., programmable non-volatile memory), input port 18, output driver 19, and user interface 20, are coupled via data bus 22. User interface 20 is, in one embodiment, a liquid crystal display (LCD) and keypad combination as found in conventional cellular telephony wireless handsets. Data bus 22 is illustrative of many interconnection topologies among the handset 10 components that may be used in various embodiments. Antenna 24 is coupled to tuner 14. Speaker 25 is coupled to, and is driven by, output driver 19.

In one instance antenna 24 receives wireless signal 26. Wireless signal 26 includes a master recording data file (compressed or uncompressed) 28. Master recording data file 28 is an audio media content item (e.g., a musical composition, sound effect, animal noise, or other sound recording). After receipt, master recording data file 28 is stored in memory 16.

In a second instance, master recording data file 28 is received via input port 18 and is stored in memory 16.

In some instances, two or more unique master recording data files 28 are received and stored in memory 16. In such instances, each unique master recording data file 28 is a unique audio media content item. An indication (e.g., a title) of the content of the one or more stored master recording data files is displayed for selection by the handset 10 user on the display portion of interface 20.

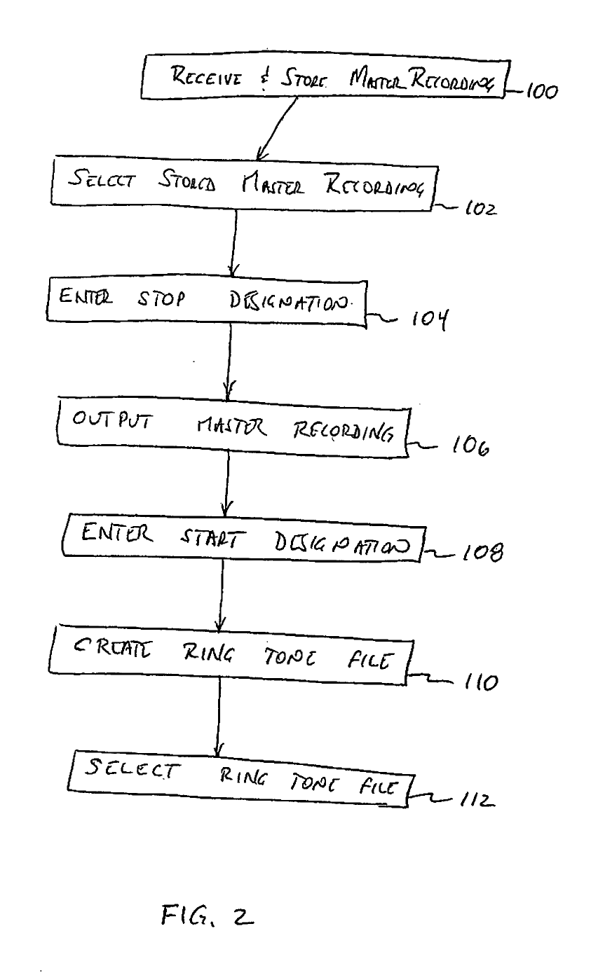

FIG. 2 is a diagrammatic view of a method of creating a ring tone file. At 100, an illustrative master recording data file 29 is received and stored in memory 16. An indication (e.g., title) of the stored master recording data file 28 content is displayed (e.g., via LCD) on user interface 20.

At 102, the user operates (e.g., manipulates one or more keypad buttons) user interface 20 to select a stored master recording data file 28 for output via output driver 19 and speaker 25.

At 104, the user operates (e.g., manipulates one or more keypad buttons) user interface 20 to enter a desired elapsed time (e.g., number of seconds) for the ring tone. This elapsed time functions as a ring tone stop designation.

At 106, the user operates (e.g., manipulates one or more keypad buttons) user interface 20 to begin output of master recording data file 28 via speaker 25.

At 108, as master recording data file 28 is output, the user listens to the output and operates (e.g., manipulates one or more keypad buttons) user interface 20 to enter a ring tone start designation.

At 110, processor 12 uses the elapsed time entered at 104 to determine the ring tone file stop point. Accordingly, the user's desired ring tone is defined between the start designation entered at 108 and the end designation entered at 104. Processor 12 then identifies the portion of master recording data file 28 that corresponds to the user's defined ring tone, and then creates a ring tone file 30 (FIG. 1) to be stored (compressed or uncompressed) in memory 16. In some instances, the user can output the defined ring tone file 30 and either approve the defined file for storage in memory 16, or repeat the method from 106 to 110 as described above. A computer-readable storage medium, such as memory 16, may be encoded with a computer program which, when loaded into a processor, such as processor 12, implements on or more aspects of the foregoing method.

In embodiments in which two or more ring tone files 30 are defined, a list of available ring tone files is output on user interface 20 (e.g., via LCD).

At 112 the user operates (e.g., manipulates one or more keypad buttons) user interface 20 to select the ring tone file to be output as the handset 10 ring tone.

In some instances the user can select and delete one or more ring tone files 30 from memory 16.

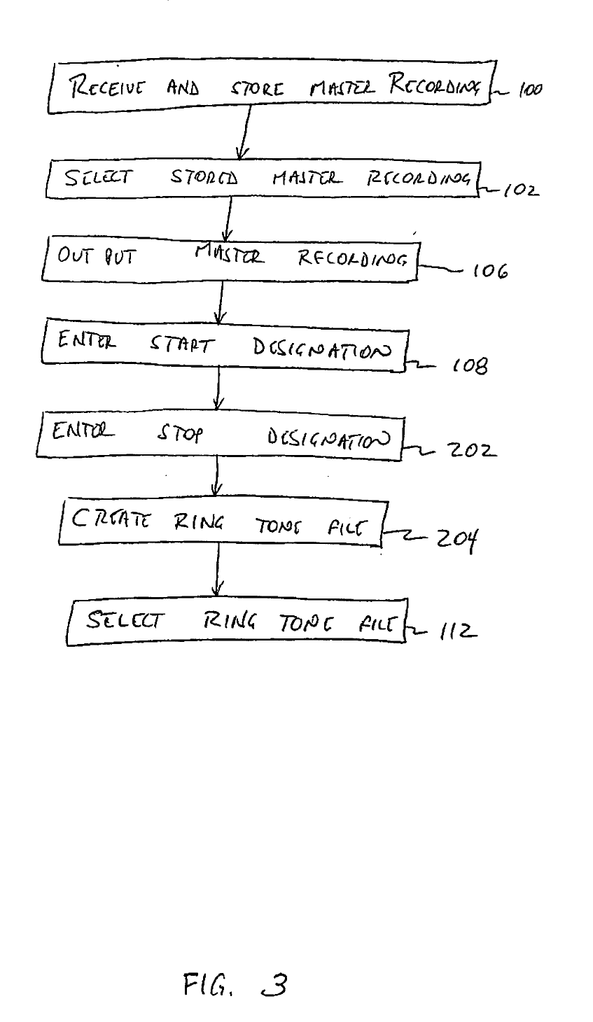

FIG. 3 is a diagrammatic view of a second method of creating a ring tone file. As shown in FIG. 3, 100, 102, 106, and 108 are executed, but 104 is skipped. Instead, after the user enters a ring tone start designation, at 202 the user operates user interface 20 to enter a ring tone end designation at a desired time during master recording data file 28 output.

At 204, processor 12 identifies the portion of master recording data file 28 that corresponds to the user's defined ring tone, and then defines ring tone file 30 to be stored in memory 16 as described above. The user then selects the stored ring tone file as described above in 112.

In some instances handset 10 is configured to allow the user to associate two or more unique ring tone files (and hence the associated unique ring tone output) to various unique input communication types. For instance, an inbound communication from a first party or source (e.g., telephone system) is associated with one ring tone and an inbound communication from a second party or source (e.g., paging system) is associated with a second ring tone. Alternatively, separate user-defined ring tones may be used for multiline systems. A computer-readable storage medium, such as memory 16, may be encoded with a computer program which, when loaded into a processor, such as processor 12, implements on or more aspects of the foregoing method.

The invention has been described in terms of specific embodiments. It is understood, however, that many variations of the described embodiments exist. Therefore, the invention is limited only by the following claims.

1. A method of creating a ring tone file, comprising the acts of:
receiving on a handset an electronic data file comprising a master recording;
receiving on the handset a ring tone start designation for a first time during an output of the master recording;
receiving on the handset a ring tone stop designation for a second time during the output of the master recording;
creating a ring tone file from a portion of the electronic data file defined by the start designation and the stop designation; and
making the ring tone file available for selection by a user.

2. The method of claim 1, wherein the ring tone stop designation comprises an elapsed time after the ring tone start designation.

3. The method of claim 1, wherein the step of receiving on the handset the electronic data file comprises receiving the electronic data file via a wireless signal.

4. The method of claim 1, further comprising:
associating the ring tone file with an input communication source.

5. The method of claim 4, wherein the step of associating the ring tone file with the input communication source comprises associating the ring tone file with one of a paging system and a telephone system.

6. A computer-readable storage medium encoded with a computer program which, when loaded into a processor, implements the method of claim 1.

7. A handset comprising:
a processor;
a memory coupled to the processor;
a user interface coupled to the processor; and a user-defined ring tone file stored in the memory, wherein the stored ring tone file is defined by the user entering a ring tone start designation for a master recording data file and by the user entering a ring tone stop designation for the master recording data file.

8. The handset of claim 7, wherein the ring tone stop designation comprises an elapsed time after the ring tone start designation.

9. The handset of claim 7, wherein the handset comprises a wireless handset.

10. The handset of claim 9, wherein the wireless handset comprises one of a cellular phone, a personal digital assistant, and a pager.

11. The handset of claim 7, wherein the user-defined ring tone file is associated with an input communication source.

12. The handset of claim 11, wherein the input communication source comprises one of a paging system and a telephone system.

13. The handset of claim 12, wherein the telephone system comprises a multiline system.

14. A method of manufacturing a wireless handset, comprising the acts of:
configuring the handset to receive an electronic data file comprising a master recording;
configuring the handset to receive a first user input, wherein the first user input enables the user to input a ring tone start designation for a first time during an output of the master recording;
configuring the handset to receive a second user input, wherein the second user input enables the user to input a ring tone stop designation for a second time during the output of the master recording;
configuring the handset to create a ring tone file from a portion of the electronic data file defined by the start designation and the stop designation; and
configuring the handset to make the ring tone file available for selection by the user.

15. The method of claim 14, wherein the ring tone stop designation comprises an elapsed time after the ring tone start designation.

16. The method of claim 14, wherein the step of configuring the handset to receive the electronic data file comprises configuring the handset to receive the electronic data file via a wireless signal.

17. The method of claim 14, further comprising:
configuring the handset to associate the ring tone file with an input communication source.

18. The method of claim 17, wherein the step of configuring the handset to associate to the ring tone file with the input communication source comprises associating the ring tone file with one of a paging system and a telephone system.
